(19) United States
(12) Patent Application Publication
(10) Pub. No.: US 2014/0344319 A1
(43) Pub. Date: Nov. 20, 2014

(54) ALGORITHM FOR PRIMALITY TESTING BASED ON INFINITE, SYMMETRIC, CONVERGENT, CONTINUOUS, CONVOLUTION RING GROUP

(71) Applicant: Daljit Singh Jandu, N. Hollywood, CA (US)

(72) Inventor: Daljit Singh Jandu, N. Hollywood, CA (US)

(21) Appl. No.: 13/893,862

(22) Filed: May 14, 2013

(51) Int. Cl. G06F 17/10

(52) U.S. Cl. CPC G06F 17/10
USPC 708/200

(57) ABSTRACT

This primality testing is based on Infinite, Symmetric, Convergent, Continuous, Convolution Ring Group. The computational complexity of any primality testing depends in the factor less than \sqrt{N} and becomes increasingly complex for large numbers as the lesser factor approaches └√N┘. But in the present algorithm the Infinite, Symmetry, Convergent, Continuous, Convolution Ring Group causes the numerator (i.e. the left side of the modulus) to converge smoothly towards └√N┘ as the testing factor approaches └√N┘. The normal operation for primality testing has computational complexity of O(n²), while the present algorithm has computational complexity of O(n·(ln(n)). By using the non-abelian group e.g. Matrix (A). Matrix (B)≠Matrix (B). Matrix (A) the security is buttressed to the highest level.

### BACKGROUND OF THE INVENTION

This invention presents fast generation and testing of large primes in innovative way for the use in cryptographic systems such as RSA. With the mass applications of data security employed by the proliferation of mobile devices such as smart phones, e-commerce, cloud computing, banking and smart card transactions etc., the larger prime numbers are constantly required to keep up with the advances in computability. The fast generation of large Prime numbers is the basis of security of every current cryptographic system e.g. RSA, Elliptical Curve Cryptography, Diffie Hellman Key Exchange or any other cryptographic protocol.

This prime number generation and testing is based on INFINITE, SYMMETRIC, CONVERGENT, CONTINUOUS, CONVOLUTION RING GROUP. The computational complexity of the prime number generation and testing depends on the factor less than \sqrt{N} and becomes increasingly complex for large numbers as the testing factor approaches \sqrt{N}. But in the present algorithm the INFINITE, SYMMETRIC, CONVERGENT, CONTINUOUS, CONVOLUTION RING GPOUP causes the numerator (i.e. the left side of the modulus) to converge rapidly towards R where R=N−└√N┘. ┌√N┐, as the testing factor approaches \sqrt{N} and thus the computational complexity for prime number generation and testing is reduced from O(n²) to O(n·Log(n)).

The concept of primality testing and factorization has been thoroughly investigated since the Euler's time. The prime numbers are ubiquitous in digital security and are the most interesting figure in number theory. Prime numbers are only divisible by themselves and 1 and have no other factor. The method to determine whether a number N is prime or not is to divide N by every number n≦\sqrt{N} and if any n divides N, it is composite and otherwise prime. This method was well known as Sieve of Eratosthenes (276 BC) and it generates all primes less than N. However this method is very slow for testing primality as it takes Ω(N) steps. For large numbers Sieve of Eratosthenes may take many thousand years for large prime number generation, testing and factoring.

There have been many thorough investigations for testing primality. These methods were either probabilistic or on the condition such as Extended Riemann Hypothesis (ERH). Yet other were based on confluence of various existing methods of pseudo prime generation or Elliptic Curve method of factorization and the primality testing which are impracticable for large prime number generation and testing.

Some modern methods of testing primality utilizes Fermat's congruence which can be written as b^{p-1}=1 mod p where b is any number and p is prime. But the Fermat Little Theorem may also satisfy the congruence b^{p-1}=1 mod n, where n is composite, called Carmichael number and hence the test is probabilistic or conditional.

In 1975 Miller used the property based on Fermat's little theorem to obtain a deterministic polynomial time algorithm. But if the algorithm asserts that a number is Prime then its primality is proven from Paeno's axioms, whereas Miler's algorithm guarantees a proof under additional assumption of the Extended Riemann Hypothesis. It was modified by Rabin to give unconditional but randomized polynomial time algorithm. Solovay and Strassen independently in 1974 obtained a randomized polynomial time algorithm using the congruence

$$( \frac{b}{n} ) = {b}^{n - 1} ( mod n )$$

for every b where

$$( \frac{b}{n} )$$

is the Jacobi symbol. Their algorithm can also be made deterministic under ERH. Since then there have been number of randomized polynomial time algorithm proposed based on different properties.

In 1983, Adleman, Pomerance and Rumely gave the deterministic algorithm for primality testing that runs in (log n)^{O(log log log n)} time. This algorithm was the generalization of Millers Algorithm and used higher reciprocity laws. In 1986 Goldwasser and Kilian proposed a randomized algorithm based on Elliptic Curves running in expected polynomial time. Atkin, Adleman and Huang modified Goldwasser-Kilian algorithm to obtain a randomized algorithm that runs in expected polynomial time. Only recently in the last decade Agrawal, Kayal and Saxena (AKS) proposed unconditional deterministic algorithm for primality testing. The primality testing of AKS algorithm is based on the identity

(X+a)ⁿ=Xⁿ+a(mod n) (1)

Where aεZ, nεN, n≧2 and (a,n)=1

However, this takes time Ω(n) because in the worst scenario we need to evaluate n coefficients on left side of the equation (1). AKS algorithm reduces the number of coefficients by appropriately choosing a small r to satisfy the equation:

(X+a)ⁿ=Xⁿ+a(mod X^{r}−1,n).

The AKS algorithm does not return factors.

The open question remained was to test the complexity of factorization of integers and the complexity class P vs. NP. Is there a polynomial time algorithm for factoring the integers? In the past there has been no polynomial time algorithm for factoring integers. We shall present such algorithm which factors any whole number in polynomial time. Later we shall also prove the related theorems for the deterministic and unconditional properties of the algorithm.

Factoring like the primality testing has long history. Euler developed a method of factorization by expressing the whole number as sum of two squares in two different ways. But because of this characteristic it shall only factor very limited number of the whole numbers. The other method is called Fermat's method of factoring, which uses the identity:

$$ab = \frac{{[ a + b ]}^{2}}{4} - \frac{{[ a - b ]}^{2}}{4}$$

Pollard Rho factoring method can only factor the small factors of the composite number. Peter Shor developed a suitable polynomial time algorithm for factoring on quantum computer. Yet another method i.e. Number Field Sieve recently used by researchers to factor RSA 768 using the computer systems of many Research Institutions with the equivalent time of 2000 years for the fastest current processor using parallel programming and if the size of the composite number is increased, the additional efforts required to factor are increased drastically. That research concluded that there exists no polynomial time algorithm for factoring in a non-quantum computer. Till now it was an open problem in computer science that there exists no polynomial time algorithm for factoring large integers.

### DESCRIPTION

This invention goes beyond Godel's Incompleteness Theorems for the solution to Hilbert's second problem. and the resolution of NP completeness for algebra and number theory and in general P=NP. Godels incompleteness are the theorems of mathematical logic that establishes inherent limitation of all but the most trivial axiomatic systems capable of doing arithmetic. The two results are widely but not universally interpreted as showing that Hilbert's interest in finding a complete and consistent set of axioms for all mathematics is impossible giving negative answers to the Hilbert's second problem. The first incompleteness theorem states that no consistent system of axioms whose theorems can be listed by an effective procedure (e.g. computer program or any sort of algorithm) is capable of proving all truths about the relations of the natural numbers i.e. arithmetic. For any such system, there will always be statements about the natural numbers that are true but improvable within the system. The second incompleteness theorem shows that such a system cannot demonstrate its own consistency.

This invention goes beyond the Godel's first and second incompleteness theorems by discovering INFINITE, SYMMETRIC, CONVERGENT, CONTINUOUS, CONVOLUTION RING GROUP that establishes NP completeness for algebra and number theory and in general P=NP. This INFINITE, SYMMETRIC, CONVERGENT, CONTINUOUS, CONVOLUTION RING GROUP has the power to solve any instances of NP complete, NP=NP hard and decision problems. At the end we prove the consistency of axioms used in the algorithms by the theorems. Accordingly, anything which can be computed mechanically can be computed in the feasible amount of time.

### The Idea

A practical and deterministic method for generating and testing large prime numbers is presented which solves the NP completeness for algebra and number theory and in general P=NP. The idea behind the primality testing with INFINITE, SYMMETRIC, CONVERGENT, CONTINUOUS, CONVOLUTION RING GROUP is that if any whole number N is divisible by [└√N┘−x], then [x²+x+R], where R=N−└√N┘. ┌√N┐, is divisible by [└√N┘−x] in the ring group i.e. (3≦x<└\sqrt{N}┘) and vice versa. By substituting y=[└√N┘−x] or x=[└√N┘−y] it can be further simplified that if a number N is divisible by y, then [y²−<└√N┘+┌√N┐>y+N] is divisible by y in the ring group i.e. (3≦y<└\sqrt{N}┘) and vice versa. The power of this algorithm is its ability for symmetric, continuous, convolution and rapid convergence of the numerator towards R as the testing factor approaches \sqrt{N} and thus the computational complexity for prime number generation and testing is reduced from O(n²) to O(n·Log(n)). The R by the definition can take the value in the range −└√N┘+1≦R≦└√N┘.

ALGORITHM I

| | |
|---|---|
| Step 1: Input N | // N is a (odd) whole number |

Step 2: If N is the perfect square, go to step 1
Step 3: Calculate R = N − └\sqrt{N}┘·┌\sqrt{N}┐
//└√N┘ returns √N rounded down to next whole number and ┌√N┐ returns
√N rounded
up to the next whole number. By its definition R can take values −└√N┘ +
1 ≦ R ≦
└√N┘
If R=0, Return
The factors of N are └√N┘ and ┌√N┐.
Else,
For (x=Int, x= [└\sqrt{N}┘ − 3], x= [symbol] √ [symbol] ┌√N┐² − N [symbol] [symbol] , x−= 2)
// Set x as an integer with initial value of x= [└\sqrt{N}┘ − 3] , make a
descending loop in the
step of 2 (to test only odd numbers) and set the final value of
x= [symbol] √ [symbol] ┌√N┐² − N [symbol] [symbol] .

| | |
|---|---|
| Evaluate Z = [x² + x + R]MOD[└√N┘ − x] | // Modular Operation |

If Z= 0, Return [└√N┘ − x] is the factor of N.
Else,
Return N is Prime.

ALGORITHM II

| | |
|---|---|
| Step 1: Input N | //N is (odd) whole number |

Step 2: If N is the perfect square, go to step 1.
Else,

For (y=Int, y =3, y = [└√N┘ − [symbol] √ [symbol] ┌√N┐² − N [symbol] [symbol] ], y+=2)

// Set y as an integer with initial value of 3, make an increment in the
steps of 2 and set
the final value to y = [└√N┘ − [symbol] √ [symbol] ┌√N┐² − N [symbol] [symbol] ].
Evaluate Z= [y² − [└√N┘ + ┌√N┐]y + n] MOD y
If Z= 0, Return y is the factor of N.
Else,
Return N is Prime.

Algorithm I and Algorithm II can be simplified as Algorithm III and Algorithm IV respectively.

ALGORITHM III

| | |
|---|---|
| Step 1: Input N | // N is (odd) whole number |

Step 2: If N is the perfect square, go to step 1.
Step 3: Calculate R = N − └\sqrt{N}┘·┌\sqrt{N}┐
If R=0, Return
The factors of N are └√N┘ and ┌√N┐.
Else,
K = └√N┘² − 5└√N┘ + R + 6
// Set the initial value of K = F(x) = x² + x + R for x= [└\sqrt{N}┘ − 3].
For (x=Int, x= [└\sqrt{N}┘ − 3], x= [symbol] √ [symbol] ┌√N┐² − N [symbol] [symbol] , x−= 2)
// Set x as an integer with initial value of x= [└\sqrt{N}┘ − 3] , make a
descending loop in the
steps of 2 and set the final value of x= [symbol] √ [symbol] ┌√N┐² − N [symbol] [symbol] .
Z = K MOD[└√N┘ − x]
K = K − 4x +2
// Assign the new values of K in the loop.
If Z= 0, Return [└√N┘ − x] is the factor of N.
Else,
Return N is Prime.

ALGORITHM IV

| | |
|---|---|
| Step 1: Input N | // N is (odd) whole number |

Step 2: If N is the perfect square, go to step 1.
K = N + 9 − 3[└√N┘ + ┌√N┐]
// Set the initial value of K = F(y) = y² − [└√N┘ + ┌√N┐]y + N for y=3.
For (y = Int, y=3, y = [└√N┘ − [symbol] √ [symbol] ┌√N┐² − N [symbol] [symbol] ], y+=2)
// Set y as an integer with initial value of 3, make an increment in the steps
of 2 and set
the final value to y = [└√N┘ − [symbol] √ [symbol] ┌√N┐² − N [symbol] [symbol] ].
Evaluate Z = K MOD y
K = K − 4[└√N┘ − y] +2
// Assign the new values of K in the loop.
If Z= 0, Return y is the factor of N.
Else,
Return N is Prime.

If the composite number has the factors of about the same size, it shall be more efficient to use the reverse direction as by Algorithms V through VIII in place of Algorithms I through IV respectively:

ALGORITHM V

| | |
|---|---|
| Step 1: Input N | // N is a (odd) whole number |

Step 2: If N is the perfect square, go to step 1.
Step 3: Calculate R = N − └\sqrt{N}┘·┌\sqrt{N}┐
If R=0, Return
The factors of N are └√N┘ and ┌√N┐.
Else,
For (x=Int, x= [symbol] √ [symbol] ┌√N┐² − N [symbol] [symbol] , x= [└\sqrt{N}┘ − 3], x+= 2)
// Set x as an integer with initial value of x= [symbol] √ [symbol] ┌√N┐² − N [symbol] [symbol] , make
an incremental loop
in the step of 2 (to test only odd numbers) and set the final value of
x = [└\sqrt{N}┘ − 3]
Evaluate Z = [x² + x + R]MOD[└√N┘ − x]
If Z= 0, Return [└√N┘ − x] is the factor of N.
Else,
Return N is Prime.

ALGORITHM VI

| | |
|---|---|
| Step 1: Input N | //N is (odd) whole number |

Step 2: If N is the perfect square, go to step 1.
Else,

For (y=Int, y = [└√N┘ − [symbol] √ [symbol] ┌√N┐² − N [symbol] [symbol] ], y= 3, y−=2)

// Set y as an integer with initial value of y = [└√N┘ − [symbol] √ [symbol] ┌√N┐² −
N [symbol] [symbol] ]. make a
decrement in the steps of 2 and set the final value of y = 3
Evaluate Z= [y² − [└√N┘ + ┌√N┐]y + N] MOD y
If Z= 0, Return y is the factor of N.
Else,
Return N is Prime.

Algorithm V and Algorithm VI can be simplified as Algorithm VII and Algorithm VIII respectively.

ALGORITHM VII

| | |
|---|---|
| Step 1: Input N | // N is (odd) whole number |

Step 2: If N is the perfect square, go to step 1.
Step 3: Calculate R = N − └\sqrt{N}┘·┌\sqrt{N}┐
If R=0, Return
The factors of N are └√N┘ and ┌√N┐.
Else,
K = [symbol] √ [symbol] ┌√N┐² − N [symbol] [symbol] ² + [symbol] √ [symbol] ┌√N┐² − N [symbol] [symbol] ² + R
// Set the initial value of K = F(x) = x² + x + R for x = [symbol] √ [symbol] ┌√N┐² −
N [symbol] [symbol]
For (x=Int, x= [symbol] √ [symbol] ┌√N┐² − N [symbol] [symbol] , x = [└\sqrt{N}┘ − 3], x+= 2)
// Set x as an integer with initial value of x= [symbol] √ [symbol] ┌√N┐² − N [symbol] [symbol] , make
incremental loop in
the steps of 2 and set the final value of x= [└\sqrt{N}┘ − 3]
Z = K MOD[└√N┘ − x]
K = K + 4x − 2
// Assign the new values of K in the loop.
If Z= 0, Return [└√N┘ − x] is the factor of N.
Else,
Return N is Prime.

ALGORITHM VIII

Step 1: Input N
Step 2: If N is the perfect square, go to step 1.
K = [└√N┘ − [symbol] √ [symbol] ┌√N┐² − N [symbol] [symbol] ]² − [└√N┘ − [symbol] √ [symbol] ┌√N┐² −
N [symbol] [symbol] ] [└√N┘ + ┌√N┐] + N
// Set the initial value of K = F(y) = y² − [└√N┘ + ┌√N┐]y + N for
y = [└√N┘ − [symbol]
√ [symbol] ┌√N┐² − N [symbol] [symbol] ]
For (y = Int, y = [└√N┘ − [symbol] √ [symbol] ┌√N┐² − N [symbol] [symbol] ], y= 3, y−=2)
// Set y as an integer with initial value of [└√N┘ − [symbol] √ [symbol] ┌√N┐² −
N [symbol] [symbol] ],, make an decrement
in the steps of 2 and set the final value to y = 3
Evaluate Z = K MOD y
K = K + 4[└√N┘ − y] − 2
// Assign the new values of K in the loop.
If Z= 0, Return y is the factor of N.
Else,
Return N is Prime.

The Algorithm can be further simplified by using the Prime Numbers in the container class and thus testing the Primality for the Prime divisors only and not for every odd number divisor and thus increasing the efficiency of the algorithm.
Now we shall prove the theorems used in the algorithm for primality testing based on INFINITE, SYMMETRIC, CONVERGENT, CONTINUOUS, CONVOLUTION RING GROUP.

### Theorem I

The expression (1)

$$\frac{{x}^{2} + x + R}{[ \sqrt{n} ] - x}$$

(algorithm I, III, V and VII) and the expression (2)

$$\frac{{y}^{2} - ( ⌊ \sqrt{N} ⌋ + ⌈ \sqrt{N} ⌉ ) y + N}{2}$$

(algorithm II, IV, VI and VIII) are identical. Proof: Put └√N┘−x=y or x=└└√N┘−y┘ in the first expression to obtain the second expression and vice versa.
The expression (1) on substitution becomes expression (2):

$$\frac{\begin{matrix}{( ⌊ \sqrt{N} ⌋ )}^{2} + {y}^{2} - \\ 2 ( ⌊ \sqrt{N} ⌋ ) y + ⌊ \sqrt{N} ⌋ - \\ y + N - ( ⌊ \sqrt{N} ⌋ ) ( ⌈ \sqrt{N} ⌉ )\end{matrix}}{y} = \frac{{y}^{2} - ( ⌊ \sqrt{N} ⌋ + ⌈ \sqrt{N} ⌉ ) y + N}{y}$$

By simply noting that ┌√N┐=└√N┘+1
Similarly the expression (2) on substitution becomes expression (1)

$$\frac{\begin{matrix}{( ⌊ \sqrt{N} ⌋ )}^{2} + {x}^{2} - \\ 2 ( ⌊ \sqrt{N} ⌋ ) x - \\ ( ⌊ \sqrt{N} ⌋ - x ) 2 ( ⌊ \sqrt{N} ⌋ + 1 ) + N\end{matrix}}{⌊ \sqrt{N} ⌋ - x} = \frac{{x}^{2} + x + R}{⌊ \sqrt{N} ⌋ - x}$$

By simply noting R=N−└\sqrt{N}┘·┌\sqrt{N}┐

### QED

In the subsequent theorems we shall use only the expression (2), i.e.

$$\frac{{y}^{2} - ( ⌊ \sqrt{N} ⌋ + ⌈ \sqrt{N} ⌉ ) y + N}{y} .$$

### Theorem II

The expression

[y²−(└\sqrt{N}┘+┌\sqrt{N}┐)y+N]
(i) Is always less than N for 0<y≦|√N|
(ii) Within the range 0<y≦|√N| has maximum value when y is at the lowest value and minimum value when y is at the highest value.
(iii) The limits [y²−(└\sqrt{N}┘+┌\sqrt{N}┐)y+N]→R as y→└√N┘ or y→┌\sqrt{N}┐ where R=N−└√N┘┌√N┐ and R by its definition take values −└\sqrt{N}┘+1≦R≦└√N┘

### Proof:

Since for 0<y≦|\sqrt{N}| the expression y²−(└\sqrt{N}┘+┌\sqrt{N}┐)y is negative and hence

y²−(└\sqrt{N}┘+┌\sqrt{N}┐)y+N<N

It may be noted that as limit y→└√N┘, the expression

[y²−(└\sqrt{N}┘+┌\sqrt{N}┐)y+N]→R

In fact by putting y=└\sqrt{N}┘ or y=┌\sqrt{N}┐, one obtains

[y²−(└\sqrt{N}┘+┌\sqrt{N}┐)y+N]=N−└\sqrt{N}┘·┌\sqrt{N}┐=R

In other words as y→√N the numerator [y²−(└\sqrt{N}┘+┌\sqrt{N}┐)y+N]→R, where R=N−└√N┘┌√N┐ and R by definition has a value in the range −└\sqrt{N}┘+1≦R≦└√N┘.

### QED

### Theorem III

For y being the factor of y²−(└\sqrt{N}┘+┌\sqrt{N}┐)y+N, the following identity holds:

y²−(└\sqrt{N}┘+┌\sqrt{N}┐)y+N≧y

(Note the upper limit for testing for y in the Algorithm II, IV, VI and VIII)

### Proof:

Let “a” be the lesser factor of N (odd whole number) and therefore the factor of the expression y²−(└\sqrt{N}┘+┌\sqrt{N}┐)y+N and N/a=b where “b” is other factor of N (Note that “b” may be composite or prime). Therefore by dividing the expression a²−(└\sqrt{N}┘+┌\sqrt{N}┐)a+N by “a” we obtain (a+b)−(└\sqrt{N}┘+┌\sqrt{N}┐)≧1, where (a+b) is the sum of two factors of N.
Note that (a+b)>(└\sqrt{N}┘+┌\sqrt{N}┐); (a+b) is even and (└\sqrt{N}┘+┌\sqrt{N}┐) is odd. Therefore (a+b)−(└\sqrt{N}┘+┌\sqrt{N}┐)≧1.
The algorithm tests from integers 3≦y≦└√N┘, but the algorithm can be terminated before y is ever reached to └√N┘ based on the identity: y²−(└\sqrt{N}┘+┌\sqrt{N}┐)y+N≧y, see Algorithm II, IV, VI and VIII.

### QED

Corollary: The Quotient of the expression y²−(└\sqrt{N}┘+┌\sqrt{N}┐)y+N when divided by lesser factor of N (also the factor of expression) say “a” is equal to (a+b)−(└\sqrt{N}┘+┌\sqrt{N}┐), where “b” is the other factor of N.

### Theorem IV

“a” is the factor of N if and only if “a” is the factor of the expression y²−(└\sqrt{N}┘+┌\sqrt{N}┐)y+N in the ring group (3≦a≦└\sqrt{N}┘) or for larger factor “b” for any N (odd whole number) and vice versa.

Proof: The expression y²−(└\sqrt{N}┘+┌\sqrt{N}┐)y+N with “a” as one of the factors in the ring group (3≦a≦└√N┘) can be expressed as a(a−(└√N┘+┌√N┐))+N. Similar expression for the larger factor “b” of N can be written as b(b−(└√N┘+┌N┐))+N.
Therefore “a” (or “b”) is the factor of N if and only if “a” (or “b”) is the factor of the expression y²−(└\sqrt{N}┘+┌\sqrt{N}┐)y+N in the ring group (3≦a≦└√N┘) or for larger factor “b” for any odd N and vice versa.

### QED

### SUMMARY OF INVENTION

### Importance

Almost every form of current computer security depends on generating large prime numbers to be used in conjunction with major security protocols such as RSA, Elliptic Curve Cryptography or Diffie Hellman Key Exchange. The RSA, Elliptical Curve Cryptography or Diffie Hellman Key Exchange derives their security from the hardness to factor large numbers. The present algorithm is the fastest deterministic algorithm to test the primality and to return the factors. The security candidates shall have to use this algorithm to find large prime numbers for the composite numbers and the primes to be used in conjunction with the RSA, Elliptical Curve Cryptography, Diffie Hellman Key Exchange or any other security protocol in accordance with the advancement of the computational power.

The important properties of this algorithm are:
(1) It is fastest deterministic algorithm to test primality and the factorization.
(2) This algorithm is universally applicable for every N (whole number). In comparison to the existing primality testing algorithms e.g. the Miller Rabin test, the AKS primality test, and otherwise too this is most efficient and practical algorithm.
(3) It solves the Hilbert's second problem, the Non Deterministic Polynomial Time Completeness for Algebra and Number theory and in general P (Polynomial Timt)=NP (Non Deterministic Polynomial Time) for all instances.

### The Trillion Dollar Phenomena

INFINITE, SYMMETRIC, CONVERGENT, CONTINUOUS, CONVOLUTION RING GROUP is a trillion dollar phenomena in form of NEXT BIG IDEA and the CAPITAL MAGNET for the Venture Capital and Private Equity markets.

### NON-PATENT CITATIONS

### References

The Riemann Hypothesis and Prime Number Theorem, Daljit S. Jandu; Infinite Bandwidth Publishing, 2006.
Handbook of Cryptography, Alfred J. Menezes, Paul C. van Oorschot, Scott A. Vanstone; CRC Press, 1996.
Prime is in P Manindra Agrawal, Kayal and Saxena: Indian Institute of Technology Kanpur, 2002.
Prime Numbers and the Computer Method of Factorization, Hans Riesel, Springer 1994.

### PATENT CITATION

| CITED | FILING | PUBLICATION | |
|---|---|---|---|
| PATENT | DATE | DATE | APPLICANT |
| U.S. Pat. No. | Jul. 31, 2003 | Mar. 18, 2008 | Agrawal, Kayal |
| 7,346,637 B2 | | | Saxena |

What is claimed is:

1) The new method for deterministically testing primality.

2) Any and all the unanticipated application of Infinite, Symmetric, Convergent, Continuous, Convolution Ring Group with some applications as following, but not limited to:
(i) Derivative application to Advanced Computer Security.
(ii) Derivative applications to Lossless Infinite Data Compression.
(iii) Derivative application to Infinite Bandwidth and Data Warehousing.
(iv) Derivative application to Error Correcting Code and Signal processing.
(v) Derivative application to the Energy Conservation and Production.
